(19) United States
(12) Patent Application Publication
(10) Pub. No.: US 2018/0104630 A1
(43) Pub. Date: Apr. 19, 2018

(54) OIL MIST SEPARATOR

(71) Applicant: TOYOTA BOSHOKU KABUSHIKI KAISHA, Aichi-ken (JP)

(72) Inventors: Naritsune MIYANAGA, Aichi-ken (JP); Yoji HORIUCHI, Aichi-ken (JP); Hideto MORISHITA, Gifu-ken (JP)

(73) Assignee: TOYOTA BOSHOKU KABUSHIKI KAISHA, Aichi-ken (JP)

(21) Appl. No.: 15/718,300

(22) Filed: Sep. 28, 2017

(30) Foreign Application Priority Data
Oct. 19, 2016 (JP) 2016-205404

(51) Int. Cl. B01D 45/08

(52) U.S. Cl. CPC B01D 45/08; F01M 13/04

(57) ABSTRACT

An oil mist separator includes: a housing which is provided separately from a body of an engine; and an oil separating part which separates oil in blow-by gas generated in the engine. The housing includes: an inlet case which is provided on the upstream side of the oil separating part; an outlet case which is provided on the downstream side of the oil separating part; and a first body case and a second body case which are disposed in series in a flowing direction of the blow-by gas and have the same shape. The oil separating part is composed of a first oil separating part and a second oil separating part which are disposed in series in a flowing direction of the blow-by gas.

### CROSS-REFERENCE TO RELATED APPLICATIONS

The present application claims priority under 35 U.S.C. § 119 of Japanese Application No. 2016-205404 filed on Oct. 19, 2016, the disclosure of which is expressly incorporated by reference herein in its entirety.

### BACKGROUND

### 1. Technical Field

The present invention relates to an oil mist separator which separates an oil component in blow-by gas generated in an engine.

### 2. Related Art

Conventionally, there has been used an oil mist separator which separates oil mist contained in blow-by gas generated in an engine and returns oil to an oil pan of the engine. When there is no mounting space, for example, in a cylinder head cover of the engine, the oil mist separator is provided at a place different from the body of the engine.

Since the flow rate of blow-by gas, for example, varies depending on the displacement of the engine, the specifications of the oil mist separator are also required to comply with it. For example, when blow-by gas flows at a high speed, the phenomenon may occur that the oil once separated in an oil separating part of the oil mist separator and discharged is sucked into a housing, scatters again, and flows out from an outflow port. Hence, in the case of such engine performance, it is necessary to take, for example, a measure of increasing the cross-sectional area of the downstream side of the housing of the oil mist separator to decrease the flow rate of blow-by gas. In this regard, JP 2015-4330 A discloses an oil mist separator having a high degree of freedom in design which is enough to comply with the engine performance.

As shown in FIG. 6, the oil mist separator described in JP 2015-4330 A is configured in such a manner that a housing 62 comprises an upstream-side half-split body 63 having an inflow port 64 for blow-by gas formed therein and a downstream-side half-split body 65 having an outflow port 66 for blow-by gas formed therein and an oil separating part 67 is held between the upstream-side half-split body 63 and the downstream-side half-split body 65. Thus, a plurality of kinds of upstream-side half-split bodies 63 or downstream-side half-split bodies 65 are prepared in advance, thereby making it possible to select, assemble and use the upstream-side half-split bodies 63 or downstream-side half-split bodies 65 which comply with the respective engine specifications. Also, the oil separating part 67 can similarly be selected and used. Hence, the degree of freedom in design of the oil mist separator 61 is enhanced.

However, as regards the degree of freedom in design of the oil separating part 67, the oil mist separator 61 described in JP 2015-4330 A is configured in such a manner that only one oil separating part 67 is provided within the housing 62, and thus can merely deal with the requests from the engine only within the range of specifications set and adjusted for the one oil separating part 67, and cannot comply with the engine specifications more finely.

### SUMMARY

An object of an embodiment of the present invention is to provide an oil mist separator which has a high degree of freedom in design of an oil separating part and can deal with the engine specifications finely.

One aspect of the present embodiments provides 1 an oil mist separator 1 comprising: a housing which is provided separately from a body of an engine; and an oil separating part which is mounted in the housing to separate oil in blow-by gas generated in the engine, wherein the housing comprises: an inlet case which is provided on the upstream side of the oil separating part; an outlet case which is provided on the downstream side of the oil separating part; and a body case which is disposed between the inlet case and the outlet case and has formed therein a drain port which discharges oil, and wherein the oil separating part includes a plurality of oil separating parts which are disposed in series in a flowing direction of the blow-by gas.

In a further aspect, the body case may include a plurality of body cases which are disposed in series in a flowing direction of the blow-by gas, and wherein the respective oil separating parts may be mounted to the respective body cases.

In a further aspect, all the body cases may be formed in the same shape.

In a further aspect, the body cases may be composed of a first body case and a second body case which have the same shape, and wherein the oil separating parts may be composed of a first oil separating part which is held between the inlet case and the first body case and a second oil separating part which is held between the first body case and the second body case.

In a further aspect, the inlet case and the outlet case may be formed in the same shape.

According to the oil mist separator of this embodiment, the oil separating part includes a plurality of oil separating parts which are disposed in series in a flowing direction of the blow-by gas. Thus, it is possible not only to set the respective oil separating parts to various specifications, but also to make the specifications of the respective oil separating parts identical with or different from each other. Therefore, the oil separating parts can be set to very various specifications as a whole, and thus can comply with the respective engine specifications more finely.

When the body case includes a plurality of body cases which are disposed in series in a flowing direction of the blow-by gas and the respective oil separating parts are provided for the respective body cases, the respective oil separating parts have only to be assembled to the respective body cases. Accordingly, the plurality of the oil separating parts are easily assembled into the housing.

Further, when all the body cases are formed in the same shape, the plurality of the body cases can be used in common. Thus, the cost can be reduced.

Furthermore, when the inlet case and the outlet case are formed in the same shape, the inlet case and the outlet case can be used in common. Thus, the cost can be reduced.

### BRIEF DESCRIPTION OF DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a vertical cross-sectional view showing an oil mist separator of an embodiment of the present invention.

FIG. 2 is an exploded cross-sectional view of FIG. 1;

FIG. 3 is an exploded perspective view of FIG. 1;

FIG. 4 is a graph of comparison in performance between the oil mist separator of the present invention and a conventional oil mist separator;

FIG. 5 is a vertical cross-sectional view showing an oil mist separator of another embodiment of the present invention; and

FIG. 6 is a vertical cross-sectional view showing the conventional oil mist separator.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Hereinafter, a detailed description will be given of an oil mist separator of an embodiment according to the present invention based on drawings.

The oil mist separator of this embodiment is an external oil mist separator which is provided separately from a body of an engine. The blow-by gas generated in the engine is returned to an intake system and re-combusted, after separation of the oil contained in the blow-by gas during passage through the oil mist separator. On the other hand, the separated oil is returned from a drain port to an oil pan. The oil mist separator is installed in the middle of a flow channel for blow-by gas.

The oil mist separator includes a housing and an oil separating part which is mounted in the housing to separate oil in the blow-by gas generated in the engine. The housing includes an inlet case, an outlet case, and a plurality of body cases. The oil separating part includes a plurality of oil separating parts which are disposed in series in a flowing direction of the blow-by gas. In this embodiment, a twin structure in which two oil separating parts are disposed in series is indicated as an example. Hereinafter, the respective members will be described in detail.

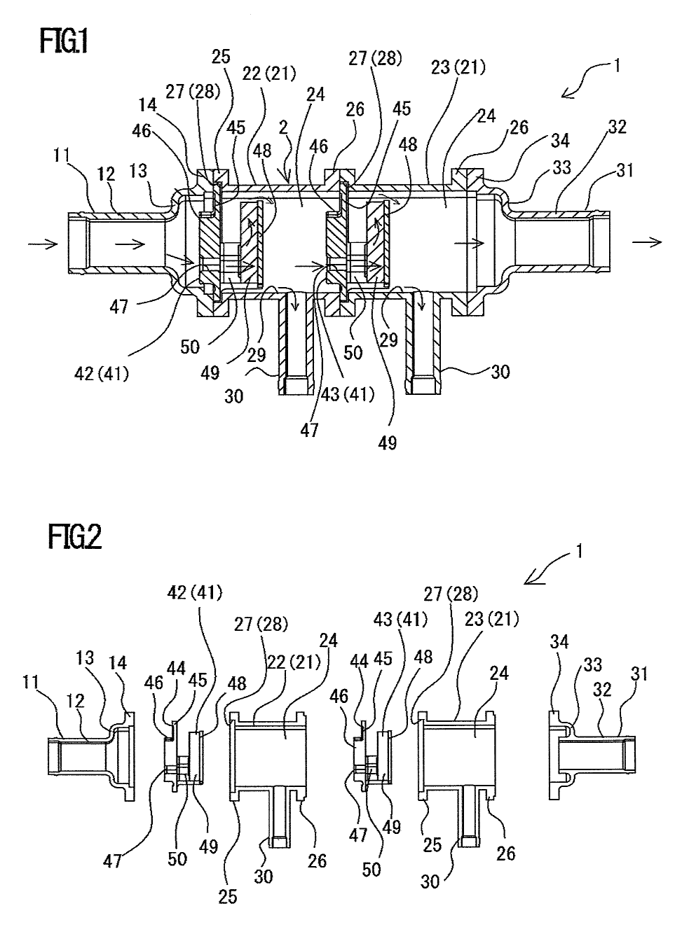

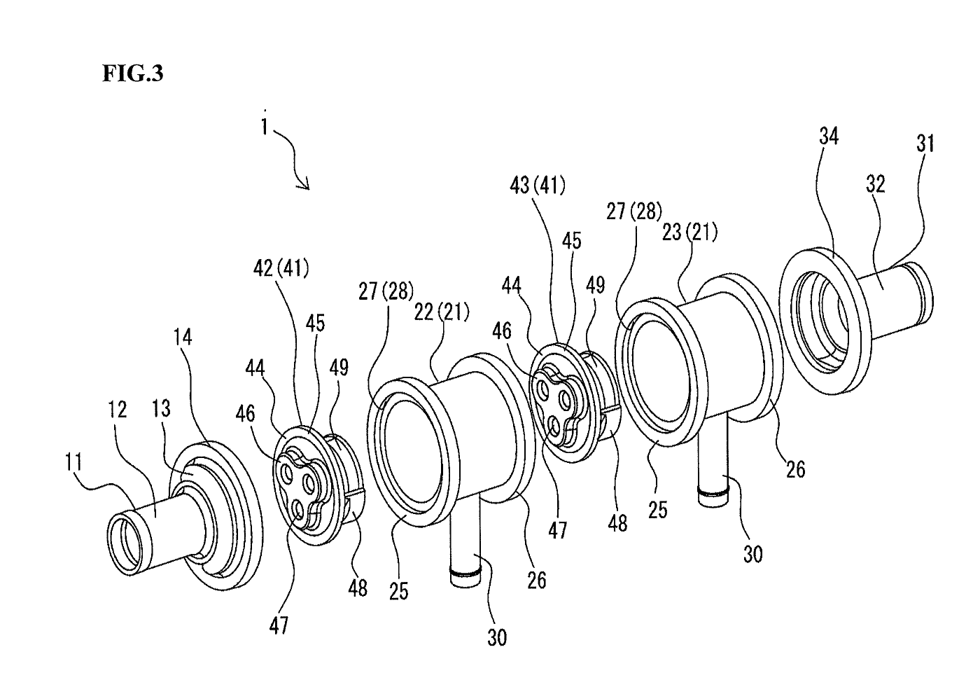

In FIG. 1 to FIG. 3, a housing 2 includes an inlet case 11 which is provided on the upstream side of oil separating parts 41, an outlet case 31 which is provided on the downstream side of the oil separating parts 41, and two body cases 21 which are disposed between the inlet case 11 and the outlet case 31. The inlet case 11 is formed with a small-diameter cylindrical pipe connection part 12 on the upstream side, and the pipe connection part 12 is connected to upstream-side piping (not shown) in the flow channel for blow-by gas. The other side of the inlet case 11 is formed in an inlet wall part 13 which is formed in a large-diameter cylindrical shape and communicates with a flow channel space of the pipe connection part 12, and a flange 14 which circularly protrudes outward is formed on the opening end side thereof. The inlet case 11 is formed of a synthetic resin.

The body cases 21 consist of a first body case 22 and a second body case 23 which are identical in all features including the material, shape, and the like. The first body case 22 and the second body case 23 are disposed in series along a flowing direction of blow-by gas on the same axis. The respective body cases are formed in a large-diameter cylindrical shape, and the internal parts thereof serve as oil separation chambers 24.

Flanges which circularly protrude outward are formed on both opening end sides of the respective body cases. Both of the flanges are formed so as to have the same outer diameter as that of the flange 14 of the inlet case 11; the upstream-side surface of a flange 25 on the upstream side of the first body case 22 abuts against the downstream-side surface of the flange 14 of the inlet case 11; and the upstream-side surface of the flange 25 on the upstream side of the second body case 23 abuts against the downstream-side surface of a flange 26 on the downstream side of the first body case 22. At these abutting portions, the respective cases are bonded to each other. The flanges 25 on the upstream side of the respective body cases each have a stepped part 27 formed therein, and the stepped part 27 has formed therein a mounting part 28 to which the peripheral end part of a partition plate part 45 of the respective oil separating parts 41 is mounted, as will be described later.

Further, a drain opening 30 which discharges the oil separated in the respective oil separating parts 41 is integrally provided vertically downward, in a position close to the downstream, in the bottom surface 29 of the respective body cases. Incidentally, pipings which connect the respective drain openings 30 and the drain pan of the engine in which the discharged oil is recovered are individually connected to the oil pan, though not shown. The respective body cases are integrally formed of a synthetic resin.

The outlet case 31 is formed of the same material and in the same shape as the inlet case 11, and composed of a pipe connection part 32, an outlet wall part 33 and a flange 34, and connected to the second body case 23 in a state where the inlet case 11 is reversed horizontally. Briefly, the inlet case 11 and the outlet case 31 are common parts and disposed symmetrically.

On the other hand, the oil separating parts 41 consist of a first oil separating part 42 and a second oil separating part 43 which are identical in all features including the material, shape, structure, and the like. The first oil separating part 42 and the second oil separating part 43 are disposed in series along a flowing direction of blow-by gas on the same axis. Specifically, the peripheral end part of the respective partition plate parts 45 is housed in the mounting part 28 of the flange 25 of the first body case 22, and held by the flange 14 of the inlet case 11 and the flange 25 of the first body case 22, whereby the first oil separating part 42 is fixed. Similarly, the peripheral end part of the respective partition plate parts 45 is housed in the mounting part 28 of the flange 25 of the second body case 23, and held by the flange 26 of the first body case 22 and the flange 25 of the second body case 23, whereby the second oil separating part 43 is fixed. The respective flanges are bonded together by vibration welding or adhesion with an adhesive. Incidentally, the respective flanges can also be bonded together by means including bolt fastening and screwing with a tapping screw, in addition to these means. When the flanges are bonded together by bolt fastening or screwing, the respective cases can be disassembled by removing a bolt or screw to replace the oil separating parts 41 located therein.

The respective oil separating parts 41 are of impactor filter type. In the respective oil separating parts 41, nozzles 47 are formed in a support body 44, and a filter 49 is mounted thereto. The support body 44 includes: a disk-shaped partition plate part 45, as a base part, having an outer diameter which is slightly smaller than the inner diameter of the stepped part 27 that forms the mounting part 28 of the flange 25 of the body case 21; and a bulging part 46 which is integrally formed on the upstream-side surface thereof and bulges out at a predetermined height. The bulging part 46 and partition plate part 45 have formed therein the nozzles 47 which penetrate these parts and includes through holes having a quite small diameter as compared with the inner diameter of the pipe connection part 12 of the inlet case 11. Three nozzles 47 are provided at equal intervals in the circumferential direction of a circle centering the center part of the bulging part 46.

On the downstream-side surface of the respective partition plate parts 45, a filter support frame 48 which consists of a half-split cylindrical portion and a disk-shaped portion is integrally projected toward the downstream side. On the filter support frame 48, a filter 49 which is made of, for example, a fibrous body such as a nonwoven fabric, paper, woven fabric or knitted fabric, a resin continuous foamed body, or a porous material is arranged in a state where the filter 49 is spaced apart from the partition plate part 45 by a predetermined distance and abutted against the disk-shaped portion of the filter support frame 48. A holding part 50 which holds the filter 49 is interposed between the filter 49 on the filter support frame 48 and the partition plate parts 45.

Next, separation of the oil in blow-by gas by the oil mist separator 1 of this embodiment configured in the above-mentioned manner will be described.

The blow-by gas generated in the engine and flowing through the flow channel flows from the inlet case 11 of the oil mist separator 1 into the first body case 22, and then passes through the three nozzles 47 of the first oil separating part 42, and is jetted out to the downstream side of the partition plate part 45 of the support body 44. At this time, the respective nozzles 47 are formed so as to have a diameter much smaller than the inner diameter of the pipe connection part 12 of the inlet case 11, and thus the blow-by gas is accelerated when passing through this portion. Then, the blow-by gas collides with the front surface of the filter 49 which is spaced apart from the partition plate part 45 by a predetermined distance. By this collision, the oil mist in the blow-by gas is trapped by the filter 49 to be separated from the blow-by gas, and dropped down along the filter 49. The gas which has collided with the filter 49 flows through a gap formed between the outer peripheral end surface of the filter 49 and the inner wall surface of the first body case 22 into the oil separation chamber 24 on the downstream side.

Also, a part of the blow-by gas flowing to the filter 49 passes through the inside of the filter 49, and, during the passage, the oil mist is trapped by the filter 49 due to its filtration, and dropped onto the bottom surface 29 of the first body case 22 by its own weight. The blow-by gas having passed through the inside of the filter 49 flows through a gap between the outer peripheral end surface of the filter 49 and the inner wall surface of the first body case 22 into the oil separation chamber 24 on the downstream side. The oil dropped onto the bottom surface 29 of the first body case 22 is discharged into the drain opening 30, returns into the oil pan of the engine, and is recovered. Thus, a considerable portion of the oil contained in the blow-by gas flowing in the inlet case 11 is separated by the first oil separating part 42.

Subsequently, the blow-by gas flowing out into the oil separation chamber 24 on the downstream side of the first body case 22 similarly flows to the second oil separating part 43 on the downstream side, is accelerated while passing through the nozzles 47 and collides with the filter 49, and a part thereof passes through the inside of the filter 49 to be filtered, so that the oil remaining in the blow-by gas without being separated by the first oil separating part 42 is trapped and separated by the second oil separating part 43. The oil dropped onto the bottom surface 29 of the second body case 23 flows to the drain opening 30, returns to the oil pan of the engine, and is recovered. The blow-by gas having passed through the second oil separating part 43 flows through the outlet case 31, passes through the flow channel, and returns to the intake system of the engine.

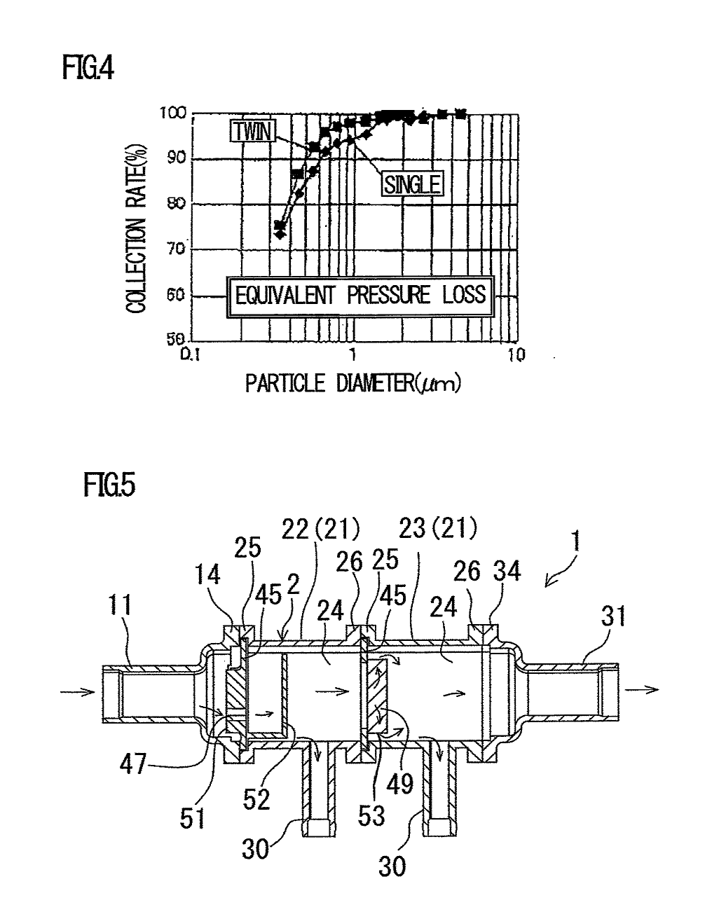

The oil mist separator 1 which separates oil in blow-by gas by means of the two oil separating parts 41 arranged in series in this way provides an equivalent or higher oil collection rate as shown in FIG. 4 and has improved performance, as compared with the conventional oil mist separator 61 in which only one oil separating part 67 is arranged in the housing 62. FIG. 4 shows experimental data obtained by measuring the collection rates for the respective particle diameters of particles collected by the entire oil mist separator under the condition of the same pressure loss, for an oil mist separator comprising only one oil separating part and an oil mist separator comprising two oil separating parts. As is evident from FIG. 4, both of the oil mist separators provide an approximately equivalent collection rate in a region with a large particle diameter, but the oil mist separator comprising two oil separating parts provides a larger collection rate in any other particle diameter regions.

The oil mist separator 1 of the above-mentioned embodiment includes the impactor filter type oil separating parts 41 which are built in the housing 2, but the present invention can similarly employ, as the oil separating parts 41, impactor type oil separating parts which cause blow-by gas jetted out from the nozzles 47 at a high speed to collide with collision walls, thereby trapping and separating the oil contained therein or filter type oil separating parts in which oil in blow-by gas is filtered, trapped and separated by the filter 49.

Next, the oil mist separator 1 of the above-mentioned embodiment employs the first oil separating part 42 and the second oil separating part 43 which are identical in all features including the material, shape, structure, and the like. However, the specifications of the respective oil separating parts may be different from each other. For example, three nozzles 47 are provided at equal intervals in a circumferential direction in the support body 44, as shown in FIG. 1 and the like, in the first oil separating part 42, whereas the nozzles 47 in the second oil separating part 43 may be different from the nozzles in the first oil separating part 42 in terms of the specifications including the number, nozzle diameter, installation position, and the like. Also, the respective oil separating parts may be different in terms of the specifications of the filter 49. Here, the two oil separating parts are desirably identical in terms of the external shape specifications including the outer diameter and plate thickness of the partition plate part 45 mounted to the body case 21. This is because the respective oil separating parts can be mounted to the body cases 21 in common.

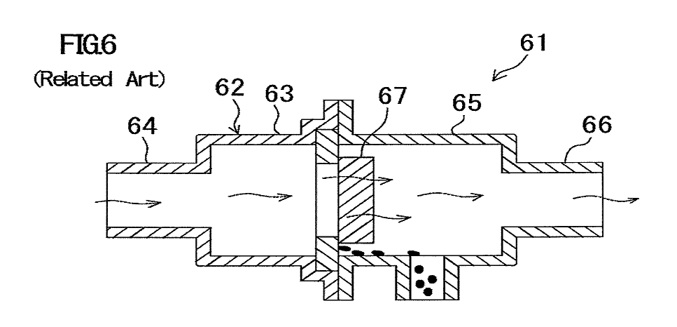

Further, the oil mist separator 1 of the above-mentioned embodiment employs the first oil separating part 42 and the second oil separating part 43 which are both impactor filter type oil separating parts, but may employ oil separating parts which are different in separation system. For example, the oil mist separator 1 can also employ an impactor type oil separating part 51 which causes the blow-by gas jetted out from the nozzles 47 to collide with the collision plate 52 to separate oil, as the first oil separating part, and a filter type oil separating part 53 which filters and separates oil by the filter 49, as the second oil separating part, as shown in FIG. 5.

In view of the above, an example of a process for producing the oil mist separator of the embodiment includes a process for producing an oil mist separator comprising oil separating parts which are composed of a first oil separating part 42 (52) and a second oil separating part 43 (53), wherein a plurality of kinds of oil separating parts are prepared as at least one of the first oil separating part and the second oil separating part, and wherein one oil separating part selected from the plurality of kinds of oil separating parts is selected and used as one of the oil separating parts. Examples of the plurality of kinds of oil separating parts mentioned above include those which are different in at least one of: the form of the nozzles 47 (for example, number, size and arrangement place); the form of the filter 49 (for example, thickness, material and density); and separation structure (for example, impactor filter type, impactor type or filter type).

Next, the action of the oil mist separator 1 of the above-mentioned embodiment will be described.

The oil mist separator 1 includes two oil separating parts which are disposed in series in a flowing direction of blow-by gas, and thus provides an increased oil collection rate and has improved collection performance under the condition of the same pressure loss, as compared with an oil mist separator which is provided with one oil separating part.

By virtue of the twin structure including two oil separating parts 41, not only the oil separating parts can be set to various specifications, but also the first oil separating part 42 and the second oil separating part 43 can be differentiated in terms of the oil separation system, the size, number and installation position of the nozzles 47, and the specifications of the filter 49 and the like. Therefore, the oil separating parts 41 can be set to very various specifications as a whole by variously combining the specifications of the respective oil separating parts. Therefore, the specifications of the oil separating parts 41 can be very finely adjusted according to the pressure loss and other conditions required for the respective engine specifications.

Further, the housing 2 is composed of two body cases 21 which are connected to each other. Thus, the respective oil separating parts have only to be assembled to the first body case 22 and the second body case 23, respectively in case units. Thus, the two oil separating parts 41 are easily assembled in the housing 2.

In addition, the first body case 22 and the second body case 23 are formed in the same shape, and also the first oil separating part 42 and the second oil separating part 43 are formed so as to have the same specifications. Therefore, it is possible to design the respective components in common, reduce the cost, and easily assemble the components.

The oil mist separator 1 of the above-mentioned respective embodiments is configured so that two oil separating parts are disposed in the housing 2, but the present invention, when implemented, may employ a structure in which three or more oil separating parts are disposed. In this case, preferably, as many body cases 21 as the oil separating parts 41 are connected in series. However, as many body cases as the oil separating parts do not necessarily have to be connected. For example, two oil separating parts 41 may be disposed in one body case in the above-mentioned embodiment.

The inlet case 11 and the outlet case 31 of the above-mentioned embodiment are formed of the same material and in the same shape, but may be formed of mutually different materials or in different shapes. For example, as regards the outlet case 31 alone, a flange which protrudes toward the side of the oil separation chamber 24 of the second body case 23 may be provided at the upstream side end part of the pipe connection part 32 in order to prevent oil from flowing to the side of the pipe connection part 32 when the oil is attached to the inner wall surface of the outlet case 31.

Additionally, the respective cases in the above-mentioned embodiment are formed in a cylindrical shape, but the present invention is not limited to this. For example, the cases may be formed in a rectangular cylindrical shape.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

The present invention is widely utilized as a technique of separating oil in blow-by gas generated in an engine.

What is claimed is:

1. An oil mist separator comprising: a housing which is provided separately from a body of an engine; and an oil separating part which is mounted in the housing to separate oil in blow-by gas generated in the engine,
wherein the housing comprises: an inlet case which is provided on the upstream side of the oil separating part; an outlet case which is provided on the downstream side of the oil separating part; and a body case which is disposed between the inlet case and the outlet case and has formed therein a drain port which discharges oil, and
wherein the oil separating part includes a plurality of oil separating parts which are disposed in series in a flowing direction of the blow-by gas.

2. The oil mist separator according to claim 1,
wherein the body case includes a plurality of body cases which are disposed in series in a flowing direction of the blow-by gas, and
wherein the respective oil separating parts are mounted to the respective body cases.

3. The oil mist separator according to claim 2, wherein all the body cases are formed in the same shape.

4. The oil mist separator according to claim 2,
wherein the body cases are composed of a first body case and a second body case which have the same shape, and
wherein the oil separating parts are composed of a first oil separating part which is held between the inlet case and the first body case and a second oil separating part which is held between the first body case and the second body case.

5. The oil mist separator according to claim 3,
wherein the body cases are composed of a first body case and a second body case which have the same shape, and
wherein the oil separating parts are composed of a first oil separating part which is held between the inlet case and the first body case and a second oil separating part which is held between the first body case and the second body case.

6. The oil mist separator according to claim 1, wherein the inlet case and the outlet case are formed in the same shape.
